(19) United States
(12) Patent Application Publication
(10) Pub. No.: US 2026/0353518 A1
(43) Pub. Date: Nov. 5, 2026

(54) HEATER MEMBER AND STEERING WHEEL

(71) Applicant: KURABE INDUSTRIAL CO., LTD., Hamamatsu-shi (JP)

(72) Inventors: Akifumi WADA, Farmington Hills, MI (US); Taiki FUJIMORI, Farmington Hills, MI (US)

(21) Appl. No.: 19/193,969

(22) Filed: Apr. 30, 2025

(51) Int. Cl. H05B 3/36; B62D 1/06; H05B 1/02

(52) U.S. Cl. CPC H05B 3/36; B62D 1/06; H05B 1/0236

(57) ABSTRACT

A heater member is formed by: a heater layer which is a first polymeric foam layer including a heater wire configured to generate heat when the heater wire is electrified; ground line layer which is a second polymeric foam layer laminated with the first polymeric foam layer while interposing a ground wire between the first polymeric foam layer and the second polymeric foam layer; and a sensor wire layer which is a third polymeric foam layer laminated with the second polymeric foam layer while interposing a sensor wire between the second polymeric foam layer and the third polymeric foam layer, the sensor wire having a capacitance with the ground wire, wherein the heater member is integrated by laminating a heater unit and a sensor unit, and the heater member is embedded under a skin of the steering wheel.

### TECHNICAL FIELD

The present invention relates to a heater member and a steering wheel. In particular, the present invention relates to a heater member having a sensor wire and a steering wheel having a sensor wire.

### BACKGROUND OF THE INVENTION

Conventionally, it is proposed to install a heater unit on a wheel portion of a steering wheel to warm the driver's hands during cold weather. The conventional heater unit disclosed in Patent Document 1 or the like is formed in a flat plate shape by interposing a heating wire between substrates.

Furthermore, since the function of the steering wheel is advanced, there is a demand for detecting whether or not the steering wheel is gripped by the driver. As a sensor unit for detecting the grip described above, a capacitive sensor can be used, for example. A two-electrode type capacitive sensor disclosed in Patent document 2 or the like is known as the capacitive sensor. When a human body approaches two electrodes that are insulated from each other in a close state, the capacitance value between the two electrodes changes. The two-electrode type capacitive sensor detects the above described change in capacitance.

The conventional heater unit and sensor unit are embedded under a skin of the steering wheel.

### PRIOR ART

[Patent document 1] WO2014/104000

[Patent document 2] WO2024/142835

### SUMMARY OF THE INVENTION

### PROBLEM TO BE SOLVED BY INVENTION

It is technically possible to embed the heater unit and sensor unit under the skin for improving the function of the steering wheel. However, since the human hands have a sensitive tactile sense, it is impossible to embed the heater unit and sensor unit under the skin without causing discomfort. For example, if the thickness of the heater unit and sensor unit increases, the steering wheel becomes thicker or the core material must be made thinner to maintain the thickness. However, discomfort is caused in either case. In addition, although conduction wires are used for the heater unit and the sensor unit, it is extremely difficult to make the presence of the heater unit and the sensor unit less perceptible while maintaining the insulation. This becomes more difficult as the number of layers of heater unit and sensor unit increases.

The present invention provides a high-functionality heater member and steering wheel without causing discomfort to the driver.

### MEANS FOR SOLVING THE PROBLEMS

The present invention is a heater member having a flat plate-shape, the heater member including: a first polymeric foam layer including a heater wire configured to generate heat when the heater wire is electrified; a second polymeric foam layer laminated with the first polymeric foam layer while interposing a ground wire between the first polymeric foam layer and the second polymeric foam layer; and a third polymeric foam layer laminated with the second polymeric foam layer while interposing a sensor wire between the second polymeric foam layer and the third polymeric foam layer, the sensor wire having a capacitance with the ground wire.

As described above, the heater member is formed by laminating the first polymeric foam layer, the second polymeric foam layer and the third polymeric foam layer. When the above described heater member is adopted in the steering wheel, the heater wire in the first polymeric foam layer can generate heat. Since the ground wire is positioned on the heater wire side of the second polymeric foam layer and the second polymeric foam layer is positioned between the ground wire and the sensor wire of the third polymeric foam layer, a predetermined capacitance occurs between the ground wire and the sensor wire. Furthermore, the sensor wire is covered by the third polymeric foam layer.

In another aspect of the present invention, the heater wire includes a heat-fusible resin layer as an outermost layer, and the first polymeric foam layer is formed by a fourth polymeric foam layer and a fifth polymeric foam layer. The first polymeric foam layer is formed by arranging the heater wire between the fourth polymeric foam layer and the fifth polymeric foam layer and heating and compressing the fourth polymeric foam layer and the fifth polymeric foam layer at a predetermined first temperature, and the fourth polymeric foam layer and the fifth polymeric foam layer are fused and adhered to the heat-fusible resin layer.

In another aspect of the present invention, the second polymeric foam layer includes a double-sided tape at a side facing the first polymeric foam layer, and the ground wire is supported by the second polymeric foam layer via the double-sided tape.

In another aspect of the present invention, the third polymeric foam layer includes a double-sided tape at a side facing the second polymeric foam layer, and the sensor wire is supported by the third polymeric foam layer via the double-sided tape.

In another aspect of the present invention, the softening temperature of the second polymeric foam layer and the third polymeric foam layer is lower than the softening temperature of the first polymeric foam layer, and the second polymeric foam layer is adhered to the first polymeric foam layer by heating and compressing the first polymeric foam layer and the second polymeric foam layer at a predetermined temperature lower than the melting temperature of the first polymeric foam layer.

In another aspect of the present invention, the heater wire has a wire diameter of less than 0.3 mm.

In another aspect of the present invention, the ground wire has a wire diameter of less than 0.3 mm.

In another aspect of the present invention, the first polymeric foam layer has open cells.

In another aspect of the present invention, the second polymeric foam layer has closed cells.

In another aspect of the present invention, the first polymeric foam layer is a polyurethane.

In another aspect of the present invention, the second polymeric foam layer is a cross-linked polyolefin.

Another aspect of the present invention is a steering wheel including a wheel portion grasped during steering, the wheel portion having: a core material; a skin covering the core material; and a heater member having a flat plate-shape, the heater member being positioned between the core material and the skin, wherein the heater member including: a first polymeric foam layer including a heater wire configured to generate heat when the heater wire is electrified; a second polymeric foam layer laminated with the first polymeric foam layer while interposing a ground wire between the first polymeric foam layer and the second polymeric foam layer; and a third polymeric foam layer laminated with the second polymeric foam layer while interposing a sensor wire between the second polymeric foam layer and the third polymeric foam layer, the sensor wire having a capacitance with the ground wire.

### EFFECTS OF THE INVENTION

The heater member of the present invention is integrated by laminating the heater unit and the sensor unit. Since the heater member is embedded under the skin of the steering wheel, a high-functionality steering wheel without causing discomfort can be provided.

### BRIEF DESCRIPTION OF DRAWINGS

FIG. 1 is a drawing schematically showing a manufacturing process of a heater member of the present invention.

FIGS. 2A - 2C are schematic diagrams of the layers constituting the heater member of the present invention.

FIG. 3 is a front view of a steering wheel to which the heater member of the present invention is applied.

FIG. 4 is a cross-sectional view of the steering wheel.

FIG. 5 is an enlarged cross-sectional view of the steering wheel.

FIG. 6 is a circuit diagram of a heater unit.

FIG. 7 is a circuit diagram of a sensor unit.

### DETAILED DESCRIPTION OF THE INVENTION

Hereafter, the embodiments of the present invention will be explained based on the drawings.

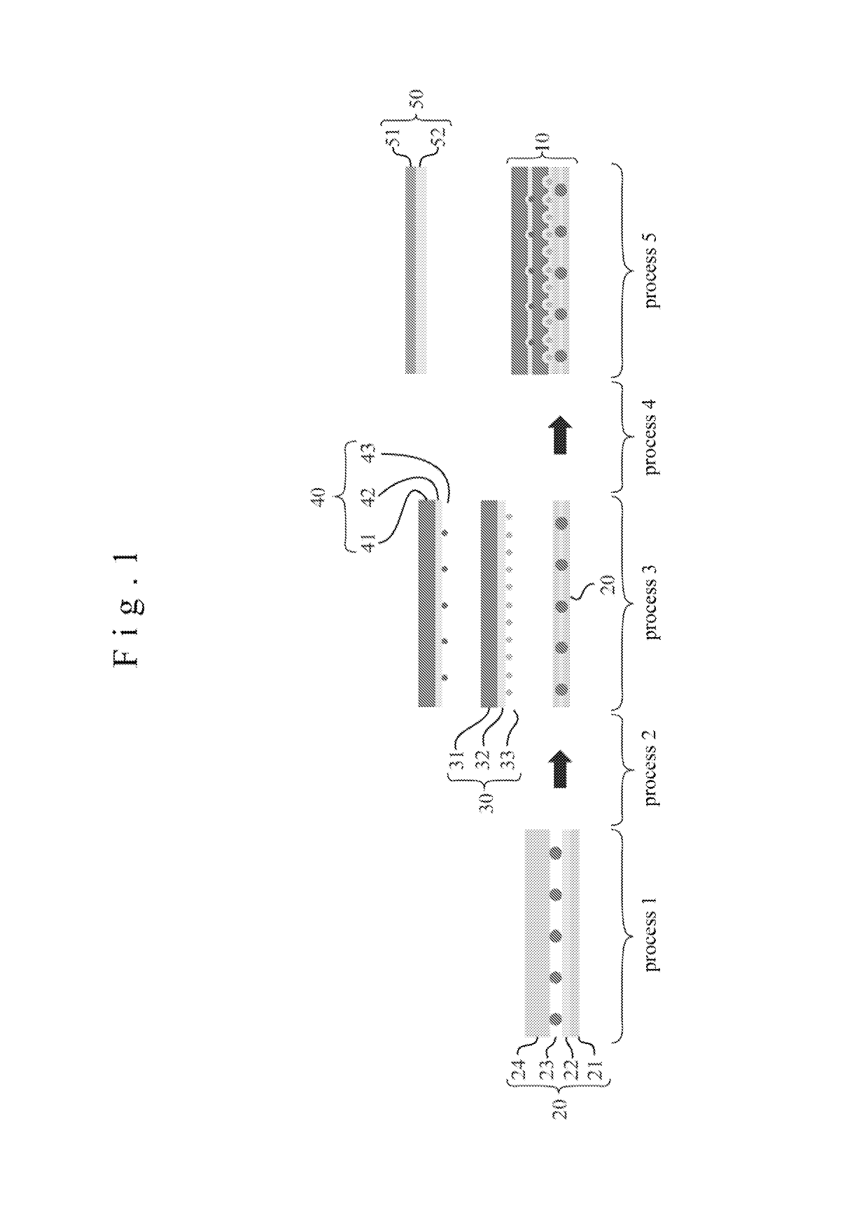

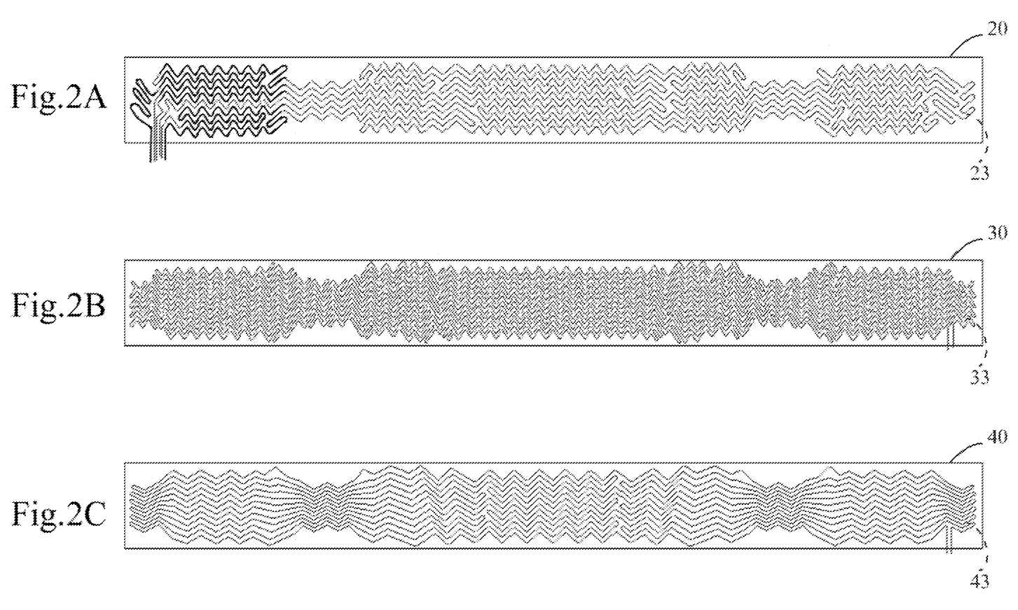

FIG. 1 schematically shows the manufacturing process of the heater member concerning an embodiment of the present invention. FIGS. 2A - 2C show the layers constituting the heater member of the present invention as the schematic diagrams.

A heater member 10 of the present invention includes a heater layer 20 shown in FIG. 2A, a ground wire layer 30 shown in FIG. 2B, and a sensor wire layer 40 shown in FIG. 2C. The heater member 10 is constructed by laminating the heater layer 20, the ground wire layer 30 and the sensor wire layer 40 as described later.

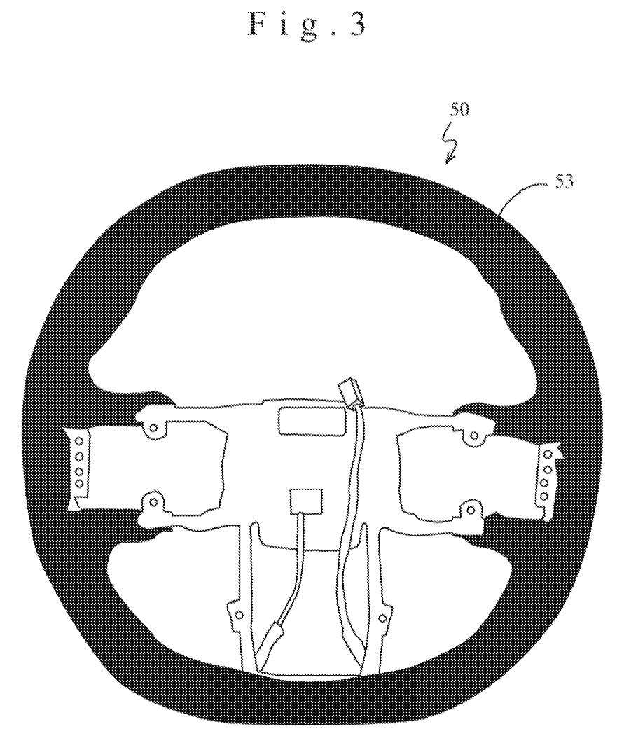

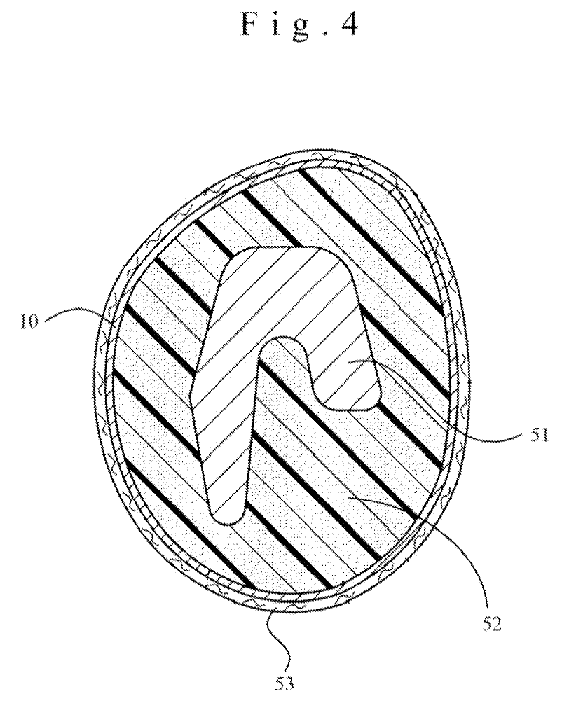

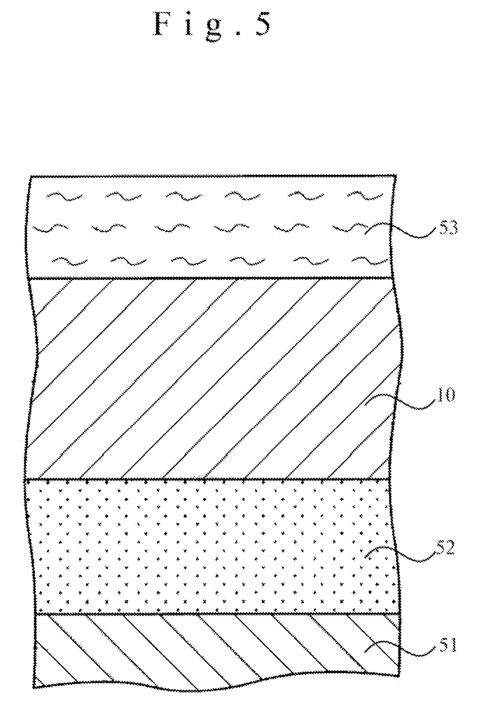

FIG. 3 shows the steering wheel to which the heater member of the present invention is applied as a front view. FIG. 4 shows the steering wheel as a cross-sectional view. FIG. 5 shows the steering wheel as an enlarged cross-sectional view.

A steering wheel 50 includes a wheel portion having a ring-shape. The wheel portion includes a core material which is formed by covering a base covering portion 52 made of urethane or the like around a wheel core material 51 made of metal. The heater member 10 having a flat plate-shape, bendability and flexibility is attached to an outer circumferential surface of the core material and further covered with a skin 53. Namely, when the driver grips and operates the steering wheel 50 during steering, the hand of the driver grips the laminated material of the skin 53, the heater member 10 and the base covering portion 52. Since the tactile sense of the human hand is sensitive, it is necessary to make the driver feel less perceptible to the heater member 10 interposed in the laminated material.

Then, the formation of the heater member will be explained with reference to FIGS. 1 and 2A - 2C.

In the figures, the heater layer 20 is constructed by laminating a polyurethane layer 21 having a thickness of 2 mm, a double-sided tape 22, a heater wire (heater line) 23 and a polyurethane layer 24 having a thickness of 6 mm using a hot press-type heater manufacturing apparatus. The heater wire 23 is prepared to form a predetermined pattern by hooking the heater wire 23 on a large number of pins placed in predetermined positions. In a state that the heater wire 23 forms a predetermined pattern, the double-sided tape 22 is preliminarily adhered to one surface of the polyurethane layer 24 having a thickness of 6 mm and the heater wire is covered with the polyurethane layer 24. Thus, the heater wire 23 having a predetermined pattern is adhered to the polyurethane layer 24. Furthermore, the polyurethane layer 21 having a thickness of 2 mm is placed facing the polyurethane layer 24 from the side of the heater wire 23 as shown in the process 1 in FIG. 1. Then, the polyurethane layer 21 and the polyurethane layer 24 are hot-pressed between the heat plates of the hot press-type heater manufacturing apparatus at approximately 230° C as shown in the process 2 in FIG. 1.

The heater wire 23 is formed with a core of 220 dtex, by twisting and aligning wires having a diameter of 0.08 to 0.11 mm, with a finished wire diameter of approximately 0.3 mm. An adhesive layer is not formed around the wires. The heater wire 23 is interposed between the polyurethane layer 21 having a thickness of 2 mm and the polyurethane layer 24 having a thickness of 6 mm, and the laminated material is compressed between heat plates at 230° C. Thus, a finished thickness of the heater layer 20 is approximately 0.8 mm.

The temperature is set at 230° C because it is sufficient to allow the cell structure in the surrounding polyurethane layers 21, 24 to be crushed and rearranged along the shape of the heater wire 23 when the heat is applied, and the binding state of hydrogen bonds by urethane bonds contained in the polyurethane molecular chains changes. Thus, the shape fixation is increased, the thickness of the heater layer 20 including the heater wire 23 is made uniform and a predetermined finished thickness is maintained.

The above described heater layer 20 is the first polymeric foam layer having the heater wire 23 configured to generate heat when the heater wire 23 is electrified. The first polymeric foam layer is the polyurethane layer. For the hot press method described above, it is preferable to adopt the polyurethane layers 21, 24 having open cells (continuous cells) so that the heater wire can be more easily embedded in the polyurethane layers 21, 24. An apparent density of the polyurethane layers 21, 24 before pressing is 40 kg/m3. Considering automotive applications, it is preferable to use the polyether-based material for the polyurethane layers 21, 24 since the polyether-based material is excellent in hydrolysis resistance.

The ground wire layer 30 is formed by laminating a cross-linked polyolefin layer 31 having a thickness of 0.8 mm, a double-sided tape 32 and a ground wire (ground line) 33. The ground wire 33 is formed by aligning and laterally winding wires having a diameter of 0.06 mm around a core of 110 dtex. A finished diameter of the ground wire 33 is approximately 0.3 mm. Similar to the heater wire 23, the ground wire 33 is formed in a predetermined pattern by hooking the ground wire 33 on a large number of pins. The ground wire layer 30 needs to have a high-density wiring pattern to prevent buffer from noise from the heater layer 20 to the sensor wire layer 40. A line pitch (pitch width) between the wires of the ground wire layer 30 is set to 3 mm.

The double-sided tape 32 is preliminarily adhered to one surface of the cross-linked polyolefin layer 31 having a thickness of 0.8 mm and the cross-linked polyolefin layer 31 is placed over the ground wire layer 30 in a state that the ground wire 33 forms a predetermined pattern. Thus, the ground wire 33 having a predetermined pattern is adhered to the cross-linked polyolefin layer 31.

The ground wire layer 30 is the second polymeric foam layer laminated with the heater layer 20 which is the first polymeric foam layer while interposing the ground wire 33 between the heater layer 20 and the ground wire layer 30. The cross-linked polyolefin layer 31 which is the second polymeric foam layer includes the double-sided tape 32 at the side facing the heater layer 20 which is the first polymeric foam layer. The ground wire 33 is supported by the cross-linked polyolefin layer 31 which is the second polymeric foam layer via the double-sided tape 32. The second polymeric foam layer is the cross-linked polyolefin layer having closed cells. Specifically, the cross-linked polyethylene can be listed as the cross-linked polyolefin layer 31. However, the cross-linked polyolefin layer 31 may be polypropylene or other known olefin materials. The cross-linking treated material is particularly preferable because heat resistance is improved and processability is also improved due to softening under heat and pressure.

Similarly, the sensor wire layer 40 is formed by laminating a cross-linked polyolefin layer 41 having a thickness of 0.8 mm, a double-sided tape 42 and a sensor wire (sensor line) 43. The sensor wire 43 is formed by aligning and laterally winding wires having a diameter of 0.06 mm around a core of 110 dtex. A finished diameter of the sensor wire 43 is approximately 0.3 mm. Similar to the heater wire 23, the sensor wire layer 40 is formed in a predetermined pattern by hooking the sensor wire 43 on a large number of pins. The pattern of the sensor wire 43 preferably has a constant number of lines in the short direction. Because of this, the change in capacitance due to gripping becomes almost constant. Thus, the accuracy of grip detection can be improved.

The double-sided tape 42 is preliminarily adhered to one surface of the ross-linked polyolefin layer 41 having a thickness of 0.8 mm and the ross-linked polyolefin layer 41 is placed over the sensor wire 43 in a state that the sensor wire 43 forms a predetermined pattern. Thus, the sensor wire 43 having a predetermined pattern is adhered to the cross-linked polyolefin layer 41.

The sensor wire layer 40 is the third polymeric foam layer laminated with the ground wire layer 30 which is the second polymeric foam layer while interposing the sensor wire 43 between the ground wire layer 30 and the sensor wire layer 40. The third polymeric foam layer is the cross-linked polyolefin layer having closed cells. Specifically, the cross-linked polyethylene can be listed also as the ross-linked polyolefin layer 41. However, the ross-linked polyolefin layer 41 may be polypropylene or other known olefin materials. The cross-linking treated material is particularly preferable because heat resistance is improved and processability is also improved due to softening under heat and pressure.

The ground wire 33 and the sensor wire 43 are arranged to form a predetermined pattern in a planar manner and curved with a predetermined distance from each other.

The ground wire layer 30 is placed on the heater layer 20 with the ground wire 33 facing downward and the sensor wire layer 40 is further placed on them with the sensor wire 43 facing downward. They are placed between the heat plates of the hot press-type heater manufacturing apparatus as shown in the process 3 in FIG. 1, and then a hot-pressing is performed at approximately 80° C as shown in the process 4 in FIG. 1. After the hot pressing, the interface between the heater layer 20 and the ground wire layer 30 and the interface between the ground wire layer 30 and the sensor wire layer 40 have the adhesive strength strong enough to cause material failure.

The finished thickness of the heater member 10 is approximately 2.6 mm as shown in the process 5 in FIG. 1. Here, the thickness of the heater layer 20 is 0.8 mm, the thickness of the ground wire layer 30 is 0.8 mm, the thickness of the sensor wire layer 40 is 0.8 mm and the thickness of the double-sided tapes 32, 42 located at each of the intermediate portions is 0.1 mm. As described above, the heater member 10 is formed in a flat plate-shape with bendability and flexibility by heat-compressing the polyurethane layer and the polyethylene layer.

Since the thickness of each of the layers is roughly 1.0 mm or less, the thickness after laminating the layers is less than 3.0 mm. Since both the heater unit and the sensor unit are provided and formed as an integrated unit with the thickness of less than 3.0 mm, wrinkles in the leather due to winding processing are less likely to occur. Thus, the driver does not feel discomfort when the driver grips the steering wheel.

Although the ground wire 33 of the ground wire layer 30 needs to have a high-density wiring pattern, the adhesion to the top and bottom surfaces deteriorates as the density increases. As described above, when the hot-pressing is performed at 80° C, a flat finish can be achieved and highly adhesive finish can be achieved in the entire surface while suppressing the shrinkage of each of the layers and suppressing the generation of air bubbles during pressing.

The heater layer 20 is formed of polyurethane while the ground wire layer 30 is formed of cross-linked polyolefin. Although the cross-linked polyolefin can be softened at approximately 80° C, the polyurethane does not melt at approximately 80° C. When the hot-pressing is performed entirely at approximately 80° C, the heater layer 20 does not melt and the cross-linked polyolefin layer 31 positioned above heater layer 20 begins to soften while the cross-linked polyolefin layer 31 is pressed onto the upper surface of the heater layer 20. Thus, the ground wire 33 is embedded mostly in the cross-linked polyolefin layer 31 side. In other words, the ground wire layer 30 is supported at the position of a predetermined height with respect to the upper surface of the heater layer 20.

On the other hand, the sensor wire 43 is positioned between the cross-linked polyolefin layer 31 of the ground wire layer 30 and the cross-linked polyolefin layer 41 of the sensor wire layer 40. When the entire structure is hot-pressed at approximately 80° C in the above described state, the cross-linked polyolefin layers 31, 41 positioned above and below the sensor wire 43 begin to soften. Thus, the sensor wire 43 becomes embedded in both cross-linked polyolefin layers 31, 41. Therefore, the sensor wire 43 is positioned approximately at the boundary between the cross-linked polyolefin layers 31, 41.

The capacitance between the ground wire 33 and the sensor wire 43 is affected by the distance between them. Since at least the position of the ground wire 33 can be accurately maintained, the capacitance can also be maintained relatively accurately.

As describe above, the softening temperature of the cross-linked polyolefin layers 31, 41 which are the second polymeric foam layer is lower than the softening temperature of the polyurethane layers 21, 24 which are the first polymeric foam layer. In addition, the cross-linked polyolefin layer 31, which is the second polymeric foam layer, is adhered to the polyurethane layers 21, 24, which are the first polymeric foam layer, by heating and compressing at a predetermined temperature lower than the softening temperature of the polyurethane layers 21, 24.

When laminating three or more polymeric foam layers, if one or more layers have open cells, the air can escape between the layers during pressing. Thus, the formation of unintended air bubbles between the layers of the heater member 10 can be suppressed. The absence of unintended air bubble allows the ground wire 33 and the sensor wire 43 to remain in place without shifting while keeping the distance between them unchanged. Thus, the capacitance can be maintained relatively accurately.

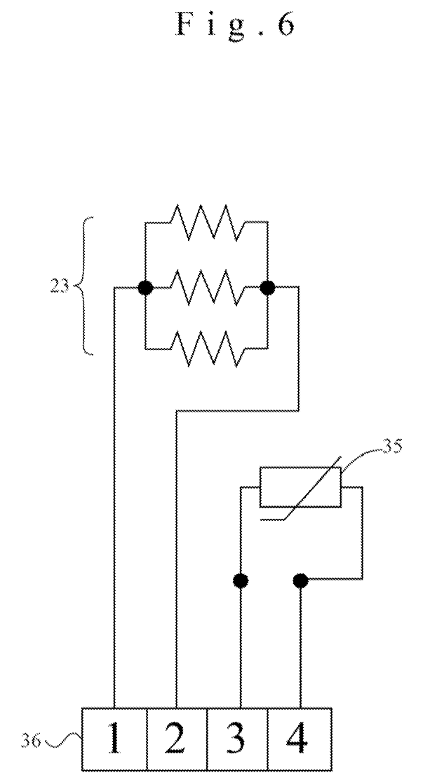

FIG. 6 is a circuit diagram of the heater unit.

The heater wire 23 is constructed with three circuits connected in parallel. In addition, a thermistor 35 is placed at a predetermined position in the heater layer 20 and is wired to a connector 36 having four terminals.

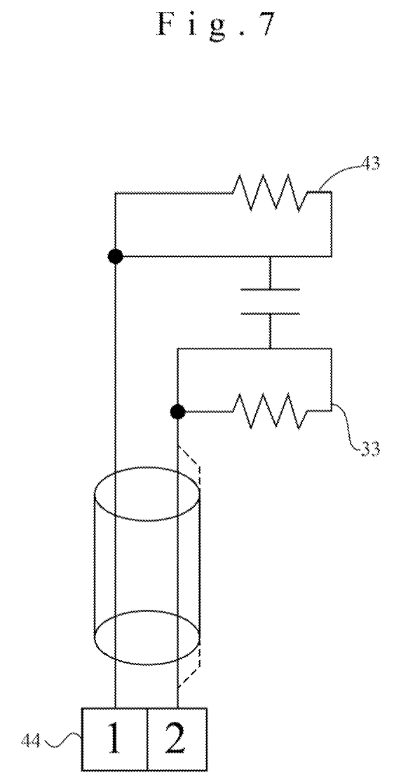

FIG. 7 is a circuit diagram of the sensor unit.

The ground wire 33 and the sensor wire 43 are directly connected to each other at each of both ends. Since the ground wire 33 and the sensor wire 43 face each other at a predetermined distance while sandwiching the cross-linked polyolefin layer 31, the capacitance occurs between them.

However, the circuit of the sensor wire 43 is not limited to the above described structure. The accuracy of the grip detection can be improved by increasing the number of circuits, such as dividing the circuit between the driver's side and the non-driver's side or between left and right.

A shielded cable for noise prevention is used for the lead wire to detect capacitance, and is wired to a connector 44 having two terminals.

In the above described embodiment, no adhesive layer is formed around the wires of the heater wire 23. However, a heat-fusible resin layer may be provided at the outermost layer of the heater wire 23. In the above described case, since the heater wire 23 is interposed between the polyurethane layer 21, which is the fourth polymeric foam layer, and the polyurethane layer 24, which is the fifth polymeric foam layer, the fourth polymeric foam layer and the fifth polymeric foam layer can be melted and adhered to the heat-fusible resin layer when the hot-pressing is performed with the hot press-type heater manufacturing apparatus.

Note that it goes without saying that the present invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

### DESCRIPTION OF THE REFERENCE NUMERALS

10: heater member,
20: heater layer,
21: polyurethane layer,
22: double-sided tape,
23: heater wire,
24: polyurethane layer,
30: ground wire layer,
31: cross-linked polyolefin layer,
32: double-sided tape,
33: ground wire,
35: thermistor,
36: connector,
40: sensor wire layer,
41: cross-linked polyolefin layer,
42: double-sided tape,
43: sensor wire,
44: connector,
50: steering wheel,
51: wheel core material,
52: base covering portion,
53: skin

1. A heater member having a flat plate-shape, the heater member comprising:
a first polymeric foam layer including a heater wire configured to generate heat when the heater wire is electrified;
a second polymeric foam layer laminated with the first polymeric foam layer while interposing a ground wire between the first polymeric foam layer and the second polymeric foam layer; and
a third polymeric foam layer laminated with the second polymeric foam layer while interposing a sensor wire between the second polymeric foam layer and the third polymeric foam layer, the sensor wire having a capacitance with the ground wire.

2. The heater member according to claim 1, wherein
the heater wire includes a heat-fusible resin layer as an outermost layer,
the first polymeric foam layer is formed by arranging the heater wire between a fourth polymeric foam layer and a fifth polymeric foam layer and heating and compressing the fourth polymeric foam layer and the fifth polymeric foam layer at a predetermined first temperature, and
the fourth polymeric foam layer and the fifth polymeric foam layer are fused and adhered to the heat-fusible resin layer.

3. The heater member according to claim 1, wherein
the second polymeric foam layer includes a double-sided tape at a side facing the first polymeric foam layer, and
the ground wire is supported by the second polymeric foam layer via the double-sided tape.

4. The heater member according to claim 1, wherein
the ground wire and the sensor wire are arranged to form a predetermined pattern in a planar manner and curved with a predetermined distance from each other, and
a pitch width of the ground wire is narrower than a pitch width of the sensor wire.

5. The heater member according to claim 1, wherein
the softening temperature of the second polymeric foam layer is lower than the softening temperature of the first polymeric foam layer, and
the second polymeric foam layer is adhered to the first polymeric foam layer by heating and compressing the first polymeric foam layer and the second polymeric foam layer at a predetermined temperature lower than the melting temperature of the first polymeric foam layer.

6. The heater member according to claim 1, wherein
the heater wire has a wire diameter of less than 0.3 mm.

7. The heater member according to claim 1, wherein
the ground wire has a wire diameter of less than 0.3 mm.

8. The heater member according to claim 1, wherein
the sensor wire has a wire diameter of less than 0.3 mm.

9. The heater member according to claim 1, wherein
the first polymeric foam layer has open cells.

10. The heater member according to claim 1, wherein
the second polymeric foam layer has closed cells.

11. The heater member according to claim 1, wherein
the third polymeric foam layer has closed cells.

12. The heater member according to claim 1, wherein
the first polymeric foam layer is a polyurethane.

13. The heater member according to claim 1, wherein
the second polymeric foam layer is a cross-linked polyolefin.

14. The heater member according to claim 1, wherein
the third polymeric foam layer is a cross-linked polyolefin.

15. A steering wheel comprising a wheel portion grasped during steering, the wheel portion having: a core material; a skin covering the core material; and a heater member having a flat plate-shape, the heater member being positioned between the core material and the skin, wherein the heater member comprising:
a first polymeric foam layer including a heater wire configured to generate heat when the heater wire is electrified;
a second polymeric foam layer laminated with the first polymeric foam layer while interposing a ground wire between the first polymeric foam layer and the second polymeric foam layer; and
a third polymeric foam layer laminated with the second polymeric foam layer while interposing a sensor wire between the second polymeric foam layer and the third polymeric foam layer, the sensor wire having a capacitance with the ground wire.
